(19) United States
(12) Patent Application Publication
(10) Pub. No.: US 2009/0002984 A1
(43) Pub. Date: Jan. 1, 2009

(54) ILLUMINATION DEVICE AND OPTICAL ELEMENT FIXING STRUCTURE

(75) Inventors: Chien-Hua Liu, Taipei (TW); Chiu-Chia Chen, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: AMA PRECISION INC., Taipei (TW)

(21) Appl. No.: 12/146,477

(22) Filed: Jun. 26, 2008

(30) Foreign Application Priority Data
Jun. 28, 2007 (TW) 96123520

(51) Int. Cl. F21V 21/00

(52) U.S. Cl. 362/237; 362/235

(57) ABSTRACT

An illumination device having an optical element fixing structure is disclosed. The illumination device includes a plurality of light emitting diodes, a plurality of lenses and a supporter. The lenses are provided on the optical paths of the light emitting diodes, and each of the lenses has a guiding part. The supporter has a plurality of holding rooms. One side of the holding room has an embedded portion. The guiding part may be guided to the embedded portion to allow the body of the lens to be provided in the holding room.

### CROSS-REFERENCE TO RELATED APPLICATION

This application claims the priority benefit of Taiwan application serial no. 96123520, filed on Jun. 28, 2007. The entirety of the above-mentioned patent application is hereby incorporated by reference herein and made a part of specification.

### BACKGROUND OF THE INVENTION

1. Field of the Invention

The invention relates to an illumination device and, more particularly, to an illumination device with an optical element fixing structure.

2. Description of the Related Art

The light emitting diode (LED) mainly is a light emitting element composed of III-V or II-IV compound semiconductor material. The light emitting principle of the LED is different from that of the conventional tungsten bulb. The tungsten bulb consumes power easily, generates a great deal of heat, lacks the feature of anti-collision and has a short lifespan. The LED has a small size, long lifespan, low driving voltage, rapid response speed and the feature of good anti-shake. Therefore, the LED is widely used in the field of electronic product such as the illumination device, traffic sign, outdoor display panel and the automobile light source.

In the household illumination device, the conventional table lamp, desk lamp or floor lamp mainly utilizes the electricity-saving lighting tube which has a long lifespan and consumes a little power as the light source. However, in the recently years, the LED technology develops rapidly, and the LED becomes a new generation illumination light source. Therefore, different LED lamp becomes commercialized. Some manufacturers emphasize that the table lamp has the feature of anti-glare and protecting eyes thus to attract the consumer. The table lamp with the feature of anti-glare and protecting eyes utilizes filters disposed under the lampshade. The reflect light and the glare that hurt eyes and interfere with the eyesight are filtered via the polarization principle. However, the brightness relatively decreases.

In addition, to gather the spot light source emitted by each LED in the table lamp to be an area light source and allow the light to illuminate evenly, the lampshade and reflector are often used to collect the useful illumination light. Conventionally, the lens assembly adheres to the lampshade by material such as glue to provide an ideal area light source to illuminate the desktop evenly.

### BRIEF SUMMARY OF THE INVENTION

The invention provides an illumination device which utilizes lenses to allow each LED to emit light evenly to provide ideal area light source.

The invention provides an optical element fixing structure, and the lenses in the optical element fixing structure are fixed on the supporter without glue, which saves time and decreases the defect rate.

The invention provides an illumination device including a plurality of LEDs, a plurality of lenses and a supporter. The LEDs are used to provide illuminative light. The lenses are provided at the optical paths of the LEDs. Each of the lenses has a body and a guiding part. The body has a light inlet surface and a light outlet surface at the opposite side. In addition, the supporter has a plurality of holding rooms for accommodating the lenses. each of the holding rooms has an embedded portion. Each of the guiding parts is guided to each of the embedded portions to allow the body of each of lenses to be held in the holding room.

The invention further provides an optical element fixing structure adapted to an illumination device having a plurality of LEDs. The optical element fixing structure includes a plurality of lenses and a supporter. The lenses are provided on the optical paths of the LEDs. Each of the lenses has a body and a guiding part, respectively. The body has a light inlet surface and a light outlet surface at the opposite side. The supporter has a plurality of holding rooms for accommodating the lenses. The holding room has an embedded portion. Each of the guiding parts is guided to each of the embedded portions.

In one embodiment of the invention, the guiding part includes a plate portion extending outside the body.

In one embodiment of the invention, the light inlet surface of each of the lenses is a concave structure. In addition, the light inlet surface may have an optical grain.

In one embodiment of the invention, the bottom of the holding room has an opening, and the light outlet surface of each of the bodies of the lenses is exposed from the opening correspondingly.

In one embodiment of the invention, the lenses and the LEDs are provided one to one or one to many.

In the illumination device having an optical element fixing structure of the invention, a plurality of lenses are provided on the optical paths of a plurality of LEDs via the supporter, and then light emitted by the LEDs is refracted via the lenses to obtain the ideal area light source which emits light evenly. In addition, the lenses are fixed on the supporter by the fastening of the holding rooms and the bodies of lenses instead of the glue. Therefore, the assembly is easy, the rework rate is low and the defect rate decreases.

These and other features, aspects, and advantages of the present invention will become better understood with regard to the following description, appended claims, and accompanying drawings.

### BRIEF DESCRIPTION OF THE DRAWINGS

FIG. 1 is a schematic diagram showing an illumination device and the optical element fixing structure thereof of an embodiment of the invention;

FIG. 2A is a top view showing the optical element fixing structure of the embodiment of the invention;

FIG. 2B is a bottom view showing the optical element fixing structure of the embodiment of the invention; and

FIG. 3 is a section view showing the lens assembled to the supporter with an inclined angle.

### DETAILED DESCRIPTION OF THE EMBODIMENTS

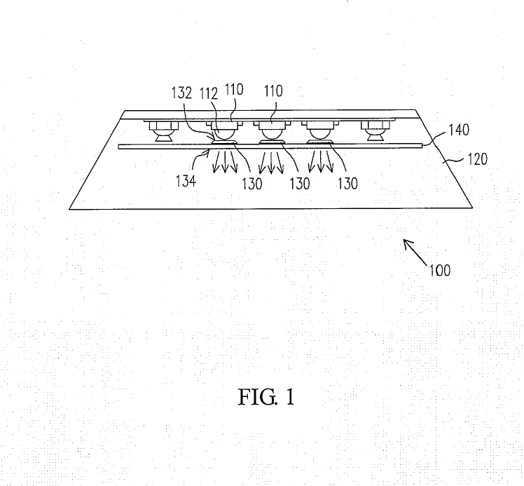

FIG. 1 is a schematic diagram showing the illumination device and the optical element fixing structure thereof of one embodiment of the invention. The illumination device is a table lamp of the embodiment of the invention. However, it also may be a torch or a computer illuminative lamp with the LEDs as the illuminative light source. For the base, power source, circuit board and the structure for supporting the lampshade of the table lamp are not the focal points of the invention. Therefore, they are described only and are not shown in drawings.

As shown in FIG. 1, the illumination device 100 has one or a plurality of LEDs 110 provided on the circuit board to receive the working current provided by the external power source to emit the light. The LEDs 110 are, for example, white LEDs or light emitting elements composed of red, green and blue LEDs. The LEDs in the embodiment are Lambertian LEDs. The semiconductor chip in the LED 110 is used as the electrode, and the transparent sealing material covers the semiconductor chip to form a light emitting area 112 for providing the needed illuminative light. The light emitted by the LEDs 110 is gathered to form an area light source from the spot light source to illuminate objects. The shade (lampshade) 120 or the reflector on the shade 120 of the illumination device is usually used to gather useful illuminative light source to increase the brightness.

In the embodiment, the illumination device 100 has an optical element fixing structure composed of at least a lens 130 and a supporter 140 and disposed in the shade 120 to increase the brightness of illumination and to allow the LEDs to emit light evenly to provide an ideal area light source. The lenses 130 are provided on the optical paths of the LEDs 110. After the light emits in through the light inlet surface 132 of the lens 130, it emits out the light outlet surface 134 at the opposite side and illuminates evenly.

The lens 130 is an optical lens having the function of controlling the light emitting angle and adjusting the light shape. The supporter 140 is made of a common transparent material such as transparent acryl, glass or other transparent material. Furthermore, the system temperature increases when the LED emits light. If the lenses 130 are fixed at the supporter 140 via the glue, the lifespan of the glue decreases under the high temperature. With the increase of the defect rate of the glue, the rework rate becomes high. Therefore, in the invention, the lenses 130 are assembled via the fixing mechanism of the supporter 140 instead of the glue to save the working time and decrease the defect rate.

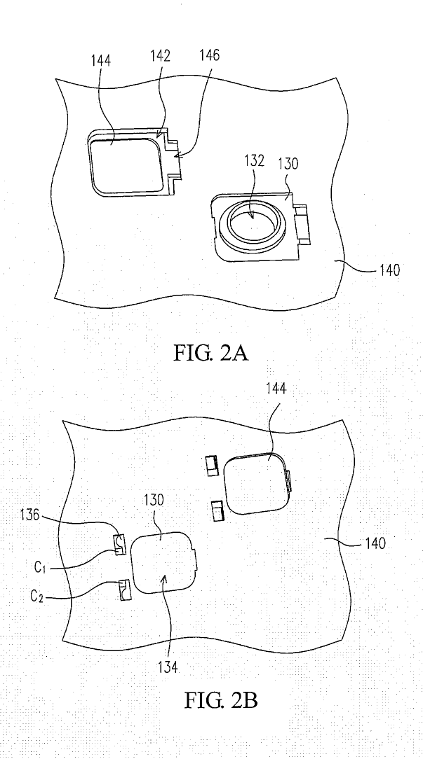

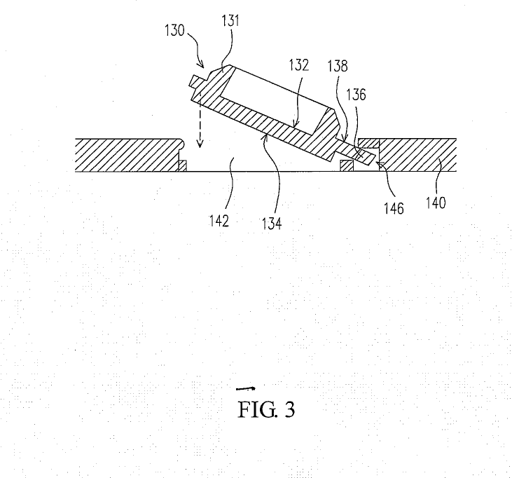

FIG. 2A is a top view showing the optical element fixing structure of the embodiment of the invention. FIG. 2B is a bottom view showing the optical element fixing structure of the embodiment of the invention. FIG. 3 is a section diagram showing a lens assembled to the supporter with an inclined angle. As shown in FIG. 2A, the supporter 140 has at least a holding room 142 for accommodating the lens 130 to the optical path of the LEDs 110 in FIG. 1. The light inlet surface 132 of the lens 130 is, for example, a concave structure with a predetermined depth. Therefore, the light emitting area 112 of the LED 110 may be partially held in the concave structure. In addition, the light inlet surface 132 of the lens 130 further may form the optical grain such as concentric circles, honeycomb or compound eyes patterns to even brightness of the light passing the lens 130. In addition, the light outlet surface 134 of the lens 130 may be a plane surface or a curved surface. The bottom of the holding room 142 has, for example, an opening 144, and the light outlet surface 134 of the lens 130 is exposed from the opening 144 correspondingly.

In FIG. 2A, one side of the holding room 142 has an embedded portion 146 which is similar to a guiding groove, and two hollow areas C1 and C2 (shown in FIG. 2B) at the bottom of the guiding groove may allow two guiding parts 136 to enter into the guiding groove in an inclined mode. Thus, the lens 130 and the holding room 142 may be fixed in a tightly fit mode with least tolerance sizes.

As shown in FIG. 3, when the lens 130 is guided in an inclined mode, the lens 130 has a guiding part 136, and the guiding part 136 includes a plate portion 138. The plate portion 138 extends outside the body 131 of the lens 130, and the thickness of the plate portion 138 is less than or equal to the maximum thickness that the embedded portion 146 may hold. Therefore, the plate portion 138 may be guided into the embedded portion 146. The body 131 of the lens 130 rotates anticlockwise relatively to the embedded portion 146 to pilot the light inlet surface to face the upward side. Then, the body 131 of the lens 130 is pressed into the holding room 142, and it may be fastened to the holding room 142 closely.

In the embodiment, although the lenses 130 and the LEDs 110 shown in FIG. 1 are provided one to one, one lens 130 also may be provided correspondingly to a plurality of LEDs 110. When one lens 130 and a plurality of LEDs 110 (such as two or three) are provided one to many, the area of the lens 130 at least covers two or more than two light emitting areas 112. In addition, in FIG. 1, besides the positive-directional emitting LEDs in the central area, the LEDs 110 also includes the side emitting LEDs at the periphery area. The light is reflected by the light barrier over the supporter 140 and the shade 120, and then it illuminates objects. Thus, the illuminative light is even. Therefore, the illuminate device 100 of embodiment of the invention does not glare or make the eyes sore and it is adapted for a long reading time. For the illumination device 100 of the invention also may utilizes the filters (not shown) disposed under the shade 120 (lampshade) to filter the reflecting light and the glare which may hurt or interfere with the vision via the polarization principle to protect the eyes.

In the embodiment, the body 131 of the lens 130 is preferred to be integrally formed with the guiding part 136 by injection molding, and the holding room 142 and the embedded portion 146 of the supporter 140 are preferred to be formed via the molding. In other embodiment, the body 131 of the lens 130 also may be fixed on the supporter 140 via the fastening structure, locking structure or structure with the feature of easy and fast assembly and easy rework to decrease the defect rate of the assembly.

To sum up, the illumination device of embodiment of the invention has an optical element fixing structure, and a plurality of lenses are provided on the optical paths of a plurality of LEDs via a supporter, and then the LEDs utilize the lenses to refract the light to obtain an ideal area light source which emits the light evenly. In addition, the lenses are fixed on the supporter via the fastening of the holding rooms and the bodies of the lenses instead of the glue. Therefore, the assembly is easy, the rework rate is low and the defect rate decreases.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. An illumination device comprising:
at least a light emitting diode for providing illuminative light;
at least a lens provided on the optical path of the light emitting diode and having a body and a guiding part, wherein the body has a light inlet surface and a light outlet surface opposite to the light inlet surface; and
a supporter having at least a holding room for accommodating the lens, wherein the holding room has an embedded portion to allow the guiding part to be guided into the embedded portion.

2. The illumination device according to claim 1, wherein the guiding part comprises a plate portion extending outside the body.

3. The illumination device according to claim 1, wherein the light inlet surface of the lens is a concave structure.

4. The illumination device according to claim 1, wherein the light inlet surface of the lens has an optical grain.

5. The illumination device according to claim 1, wherein the light outlet surface of the lens is a plane surface or a curved surface.

6. The illumination device according to claim 1, wherein the bottom of the holding room has an opening, and the light outlet surface of the lens is exposed from the opening correspondingly.

7. The illumination device according to claim 1, wherein the material of the supporter comprises acryl.

8. The illumination device according to claim 1, wherein the lens and the light emitting diode are disposed one to one.

9. The illumination device according to claim 1, wherein the lens and the light emitting diode are disposed one to many.

10. An optical element fixing structure applied to an illumination device having at least a light emitting diode, the optical element fixing structure comprising:
at least a lens provided at the optical path of the light emitting diode and having a body and a guiding part, wherein the body has a light inlet surface and a light outlet surface opposite to the light inlet surface; and
a supporter having at least a holding room for accommodating the lens, wherein the holding room has an embedded portion to guide the guiding part into the embedded portion.

11. The optical element fixing structure according to claim 10, wherein the guiding part comprises a plate portion extending outside the body.

12. The optical element fixing structure according to claim 10, wherein the light inlet surface of the lens is a concave structure.

13. The optical element fixing structure according to claim 10, wherein the light inlet surface of the lens has an optical grain.

14. The optical element fixing structure according to claim 10, wherein the light outlet surface of the lens is a plane surface or a curved surface.

15. The optical element fixing structure according to claim 10, wherein the bottom of the holding room has an opening, and the light outlet surface of the lens is exposed from the opening correspondingly.

16. The optical element fixing structure according to claim 10, wherein the material of the supporter comprises the acryl.

17. The optical element fixing structure according to claim 10, wherein the lens and the light emitting diode are disposed one to one.

18. The optical element fixing structure according to claim 10, the lens and the light emitting diode are disposed one to many.
